(19) United States
(12) Patent Application Publication
(10) Pub. No.: US 2004/0109565 A1
(43) Pub. Date: Jun. 10, 2004

(54) Method and system for encrypting or decrypting an image code block

(76) Inventors: Takeyuki Uehara, Wollongong (AU); Reihaneh Safavi-Naini, Wollongong (AU); Philip Ogunbona, Figtree Wollongong (AU)

Correspondence Address: MOTOROLA, INC., 1303 EAST ALGONQUIN ROAD, IL01/3RD, SCHAUMBURG, IL, 60196

(21) Appl. No.: 10/313,645

(22) Filed: Dec. 6, 2002

(51) Int. Cl. H04K 1/00

(52) U.S. Cl. 380/269

(57) ABSTRACT

A method (40) and system (1) for bit modeling and encrypting a code block created from an image. There is also provided a method (60) and system (20) for inverse bit modeling and decrypting an encrypted version of the code block comprising context dependent sequence of bits. Both methods (40,60) and systems (1,20) use a respective encrypting sequence or decrypting sequence associated with an encryption key or seed. The method (40) effects a conducting coefficient bit modeling (46) on at least part of a selected code block in a bit modeling order identified by the encrypting sequence. The method (60) effects a constructing coded wavelet coefficients (66) from the context dependent modeled sequence of bits in an order identified by the decrypting sequence.

### FIELD OF THE INVENTION

This invention relates to a method, and system for bit modeling and encrypting or inverse bit modeling and decrypting a code block created from an image. The invention is particularly useful for, but not necessarily limited to, encrypting and decrypting compressed images that have been typically compressed by the Joint Photographic Experts Group (JPEG) standard, typically the JPEG 2000 standard or other similar compression coding techniques.

### BACKGROUND ART

In order to cope with image data transmission bandwidths limitations and memory overheads, data compression or coding techniques have been developed to for reducing the total amount of information required to represent an image. Several types of data compression and coding methods are well known in the art, such as that using orthogonal transformation and the JPEG 2000 standard.

The JPEG 2000 standard, like other image coding techniques, can be divided into a number of sub-processes including decomposition, quantization and entropy coding. Usually, decomposition is performed by a transformation such as Discrete Cosine Transform (DCT), wavelet transform or some other orthogonal transformation. The output of the transformation is a set of coefficients of an original image with desirable properties such as optimal energy packing. In particular, the purpose of the transform is to reorganize image pixel data in such a way that it is possible to discard some pixel data without impacting the quality of an inverse transformed version of the original image that is provided by a decoding process.

Although data compression coding techniques are highly beneficial, they do not readily allow for encryption as this will decrease compression efficiency. It would therefore be useful if suitable encryption and decryption methods and systems could be, used for data compression coding techniques, in order to provide at least some security capability.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for bit modeling and encrypting a code block created from an image, the code block comprising a set of coded wavelet coefficients, the method comprising:

selecting the code block;

providing a coefficient bit modeling encrypting sequence; and

conducting coefficient bit modeling on at least part of the selected code block in a bit modeling order identified by the encrypting sequence, the bit modeling providing a context dependent modeled wavelet sequence of bits for the selected code block, the wavelet sequence providing an encrypted version of the code block.

Preferably, there may be a different bit modeling order for different bit planes of the selected code block, the order being controlled by the encrypting sequence.

Suitably, the method may be performed on other code blocks of the image with a different said encrypting sequence thereby resulting in a different said order for different code blocks.

Preferably, the encrypting sequence may be used during the selecting to thereby select the code block in an order identified by the encrypting sequence.

The conducting coefficient bit modeling may be followed by arithmetic encoding the modeled wavelet sequence of bits.

Preferably, the method may be selectively applied to one or more blocks of coded wavelet coefficients associated with bands derived from the image during decomposing.

Suitably, the encrypting sequence may be obtained by a pseudo-random number generation.

According to another aspect of the invention there is provided a method for inverse bit modeling and decrypting a bit modeled and an encrypted version of a code block for an image, the bit modeled and an encrypted version of the code block comprising a context dependent modeled sequence of bits, the method comprising:

obtaining the encrypted version of the code block;

providing an inverse bit modeling decrypting sequence; and

constructing coded wavelet coefficients from the context dependent modeled sequence of bits in an order identified by the decrypting sequence, the constructing providing a decrypted version of the code block.

Preferably, there may be a different inverse bit modeling order for different bit planes of the selected code block, the order being controlled by the decrypting sequence.

Suitably, the method may be performed on other code blocks of the image with a different said decrypting sequence thereby resulting in a different said order for different code blocks.

There may suitably be arithmetic decoding of the modeled wavelet sequence of bits is performed prior to the conducting coefficient inverse bit modeling.

Preferably, the method may be selectively applied to one or more blocks of coded wavelet coefficients associated with bands derived from the image.

Suitably, the decrypting sequence may be obtained by a pseudo-random number generation. The decrypting sequence may be associated with a shared key used to create the bit modeled and an encrypted version of a code block.

According to another aspect of the invention there is provided a decoder system for inverse bit modeling and decrypting a bit modeled and an encrypted version of a code block for an image, the bit modeled and an encrypted version of the code block comprising a context dependent modeled sequence of bits, the decoder system comprising:

a processor providing an inverse bit modeling decrypting sequence;

an input module for obtaining the encrypted version of the code block; and

a coefficient inverse bit modeling module coupled to the input module and the processor, wherein in use, the inverse bit modeling module constructs coded wavelet coefficients from the context dependent modeled sequence of bits in an order identified by the decrypting sequence, to provide a decrypted version of the code block.

Suitably, the processor may include a pseudo-random number generator for providing the decrypting sequence.

Preferably, the decrypting sequence may be associated with a shared key used to create the bit modeled and an encrypted version of a code block.

The decoder may suitably include a display module coupled to the coefficient inverse bit modeling module.

There may be a wavelet synthesis module coupling said display module to said inverse bit modeling module.

There may suitably be an arithmetic decoder module coupling said input module to said module coupling said inverse bit modeling module.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram of an image encoder system in accordance with the present invention;

FIG. 2 is a block diagram of an image decoder system in accordance with the present invention;

FIG. 3 is a flow diagram illustrating a method for bit modeling and encrypting a code block created from an image in accordance with the present invention;

FIG. 4 is a flow diagram illustrating a for inverse bit modeling and decrypting a bit modeled and an encrypted version of a code block for an image encrypted by the method of FIG. 3, in accordance with the present invention;

FIG. 5 illustrates conceptually a code block used in the JPEG 2000 standard; and

FIGS. 6a and 6b illustrates conceptually possible bit plane coding encryption sequences for a most significant bit plane and least significant bit plane of the code block of FIG. 5.

### DETAILED DESCRIPTION OF THE PREFERRED EMBODIMENT OF THE INVENTION

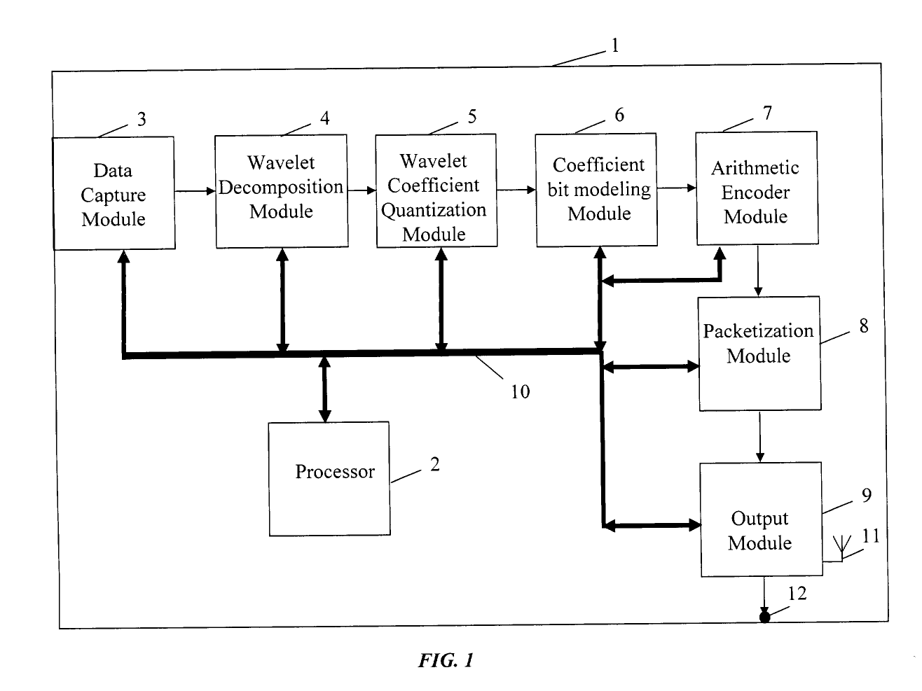

In the drawings, like numerals on different Figs are used to indicate like elements throughout. With reference to FIG. 1, there is illustrated a block diagram of an image encoder system 1. The system 1 comprises a data capture module 3 that is typically a camera or an input port with either or both radio reception capabilities and hard-wired connector capabilities for downloading, and storing, images from networks or disk drives.

The system 1 also includes a wavelet decomposition module 4 with an input coupled to an output of the data capture module 3. An output of the wavelet decomposition module 4 is coupled to an input of a Wavelet coefficient quantization module 5. There is also a coefficient bit modeling module 6 having an input coupled to an output of the Wavelet coefficient quantization module 5 and an output of the coefficient bit modeling module 6 is coupled to an input of an arithmetic decoder module 7. The system 1 also has a packetization module 8 with an input coupled to an output of the arithmetic decoder module 7 and an output of the packetization module 8 is coupled to an output module 9. The output module 9 has an output port connector 12 and an antenna 11 for transmitting, or allowing storage of, encrypted decoded images coded and encrypted by the system 1 to networks, disk drives and the like. There is also a processor 2 (with an associated memory not illustrated) having a common address and data bus 10 coupled to modules 3,4,5,6,7,8 and 9. In use, and as will be apparent to a person skilled in the art, the processor 2 controls the operation of the system 1.

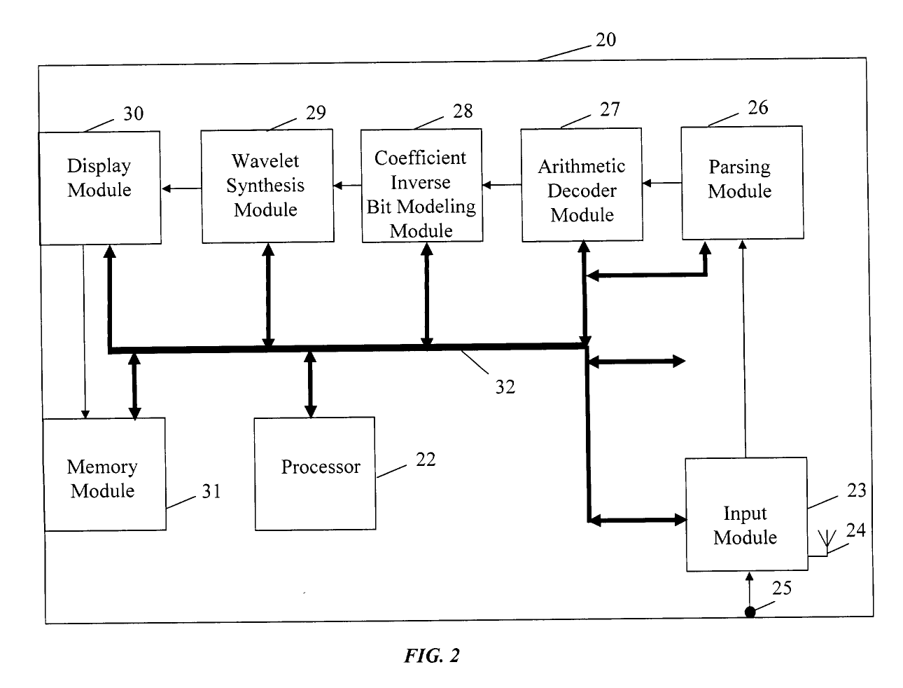

With reference to FIG. 2, there is illustrated a block diagram of an image decoder system 20. The system 20 comprises an input module 23 with an input port connector 25 for downloading, and storing, coded encrypted images from networks or disk drives. The input module 23 also has an antenna 24 for receiving radio transmitted encrypted coded images.

The system 20 includes a parsing module 26 with an input coupled to an output of the input module 23. An output of the parsing module 26 is coupled to an input of an arithmetic decoder module 27. There is also a coefficient inverse bit modeling module 28 having an input coupled to an output of the arithmetic decoder module 27 and an output of the coefficient inverse bit modeling module 28 is coupled to an input of a wavelet synthesis module 29. An output of the wavelet synthesis module 29 is coupled to a display module 30 such as a Liquid Crystal Display or any other screen that can display images. The display module 30 has an output coupled to a memory module 31 that can store images and can be coupled to other devices for loading and unloading such images.

There is also a processor 22 (with an associated memory not illustrated) having a common address and data bus 32 coupled to modules 23,26,27,28,29,30 and 31. In use, and as will be apparent to a person skilled in the art, the processor 22 controls the operation of the system 20.

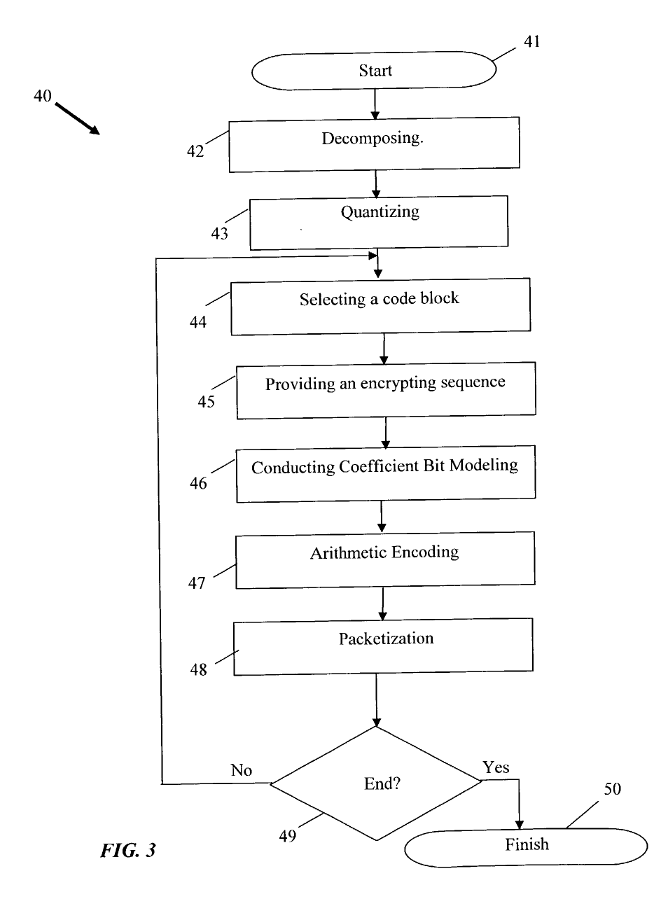

In the following bit modeling and encrypting methods, or inverse bit modeling and decrypting methods, JPEG 2000 is used as the preferred encoding and decoding standard. With this in mind, referring to FIG. 3, there is illustrated a method 40 bit modeling and encrypting a code block created from an image provided by the data capture module 3. As will be apparent to a person skilled in the art the code block set of coded wavelet coefficients. At a start step 41 the data capture module 3 provides digital input image data representing an image to the wavelet decomposition module 4 where decomposing 42 is effected using a wavelet transform. The wavelet transform employs a pair of complimentary filters that are applied on the input image data to obtain a set of wavelet coefficients organized into four bands and is well know in the JPEG 2000 standard. There is a band that captures the low frequency content of the image; there is another band that captures the horizontally oriented structures in the image; there is yet another band that captures the vertically oriented structures in the image; and finally there is the band that captures the diagonally oriented structures in the image. Collectively, these are called sub-bands and the number of wavelet coefficients in each of the four sub-bands is a quarter of the size of the original image.

Decomposing 42 can be repeated several times, each time the operation is performed on the band of coefficients capturing the low frequency content of the image. Each decomposition, that is effected during decomposing 42, is referred to as a “level of decomposition”. In JPEG 2000, decomposition is achieved using either the (9,7) floating point wavelet of the (5,3) integer wavelet as will be apparent to a person skilled in the art.

The output wavelet coefficients from the Wavelet Decomposition module 4 are, depending on the wavelet filter used by module 4, either integers or floating point numbers. These coefficients are passed to the Wavelet Coefficient Quantization module 5 where Quantizing 43 is then effected in order to limit the range of values the coefficients can assume. This is achieved by dividing the magnitude of each wavelet coefficient by a quantization step size and rounding down the quotient. Accordingly, the number of bits required to represent each coefficient is specified in a sign-magnitude format. The signs are modeled and coded separately from the magnitudes as described in D. S. Taubman and M. W. Marcellin, JPEG2000: Image Compression Fundanmentals, Standards and Practice, Kluwer Academic Publishers Group, 2002.

After quantizing 43, the wavelet coefficients are partitioned into non-overlapping rectangles of code blocks. The code blocks are the smallest independent units in the JPEG 2000 coding scheme. Coefficient code block sizes are typically, 32×32 or 64×64 to provide acceptable compromise for a wide range of applications.

In JPEG 2000, each code block is coded independently so as to allow for various forms of progressive reconstruction, for example, progression by resolution. The method 40 after quantizing effects a selecting a code block step 44, and then a step of providing a coefficient bit modeling encrypting sequence 45, performed by processor 2, provides an encrypting sequence. The encrypting sequence is a list of numbers (or a data) identifying a sequence of bit plane stripes as will be described later. The encrypting sequence must be known by both the encoder system 1 and at least one decoder system 20. Consequently, an encryption key (or seed) has to be transmitted between system 1 and system 20 secure manner (or in one alternative the key, or sequence, may be downloaded by disk by a user or programmed during manufacture). Typically, any of the key exchange algorithm known in the art can be employed used between system 1 and system 20 such as the Diffie-Hellman key exchange algorithm described in A. J. Menezes et al “Handbook of Applied Cryptography” CRC Press October 1996, which is incorporated into this specification, by reference. The encrypting sequence may therefore be created by pseudo-random number generation, provided by the processor 2, having an initial state provided by the encryption key (seed).

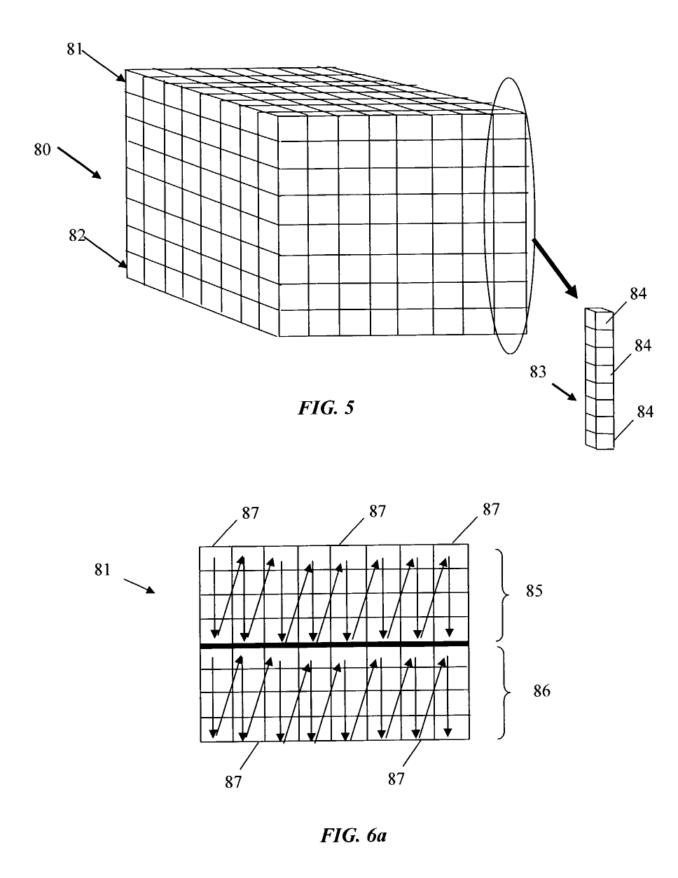

The method 40 then performs conducting coefficient bit modeling 46 and arithmetic encoding 47. The coefficient bit modeling is performed on the selected code block 80 in a bit modeling order, identified by the encrypting sequence, where the bit modeling module 6 operates in tandem with the arithmetic coder module 7 to perform a context-dependent binary arithmetic coding of the bit planes of each code block. In this regard, referring temporarily to FIG. 5 there is illustrated a conceptual representation of a code block 80 comprising horizontal bit planes representing quantized wavelet coefficients. Each small rectangular block 84 in a vertical single column of bits 83, is a bit in the sign-magnitude binary representation of a wavelet coefficient. A most significant horizontal bit plane 81 is a top horizontal plane and a least significant bit plane 82 is a bottom 82 horizontal slice of the code block 80. The code block 80 is therefore a stack of binary arrays of horizontal bit planes (for example planes 81 and 82).

Returning back to FIG. 3, the conducting coefficient bit modeling 46 and arithmetic encoding 47 sequentially selects each horizontal bit plane of the code block 80 that is then modeled into a binary and context decision, by the bit modeling module 6, that is passed to the arithmetic encoder 7. As will be apparent to a person skilled in the art, the arithmetic encoder 7 is a context dependent binary coder where a “significance state” of each bit of the code block 80 along with the context of neighboring bits is encoded.

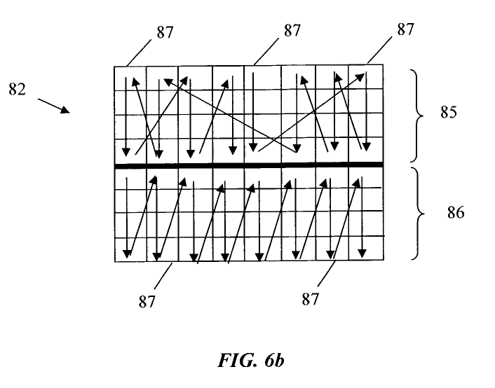

During bit modeling 46 and arithmetic encoding 47 on the selected code block 80, the bit modeling 46 provides a modeled wavelet sequence of bits for the selected code block 80, the wavelets sequence of providing an encrypted version of the code block. For instance, referring temporarily to FIGS. 6a and 6b, there is illustrated conceptually possible bit plane coding encryption sequence for a most significant bit plane 81 and least significant bit plane 82 of the code block 80. Modeling starts with the most significant bit plane 81 and sequentially works down the bit planes towards the least significant bit plane 82. Each of the bit planes is encoded in three coding passes, namely, significance, magnitude refinement and clean-up.

Within each bit plane, for instance plane 81, the bits are grouped into stripes 87 of four bits comprising an upper stripe group 85 and a lower stripe group 86. However, many more stripe groups are possible per bit plane. Typically, each stripe 87 of four bits is encoded together in the JPEG 2000 standard. A defined scan pattern, based on the encryption sequence, determines how the bit plane is encoded in an encryption sequence shown by the arrows representing a raster for significant bit plane 81 of FIG. 6a and another encryption sequence is shown for the least significant bit plane 82 of FIG. 6b. This is done until the entire bit planes of the code block have been modeled and passed on to the arithmetic coder 7. It should be noted that the encrypting sequence can provide for different bit modeling orders for different bit planes of a code block and also different bit modeling orders for different code blocks. Hence, after steps 46 and 47, there is provided a context dependent modeled wavelet sequence of bits for the selected code block 80, the wavelet sequence providing an encrypted version of the code block 80. It should also be noted that the encrypting sequence may be used during the selecting 44 to thereby select the code block in an order identified by the encrypting sequence.

After step 47 packetization 48 is performed by the packetization module on the context dependent modeled wavelet sequence of bits for the selected code block and then resulting packets of the context dependent modeled wavelet sequence of bits for the selected code block code (typically a JPEG2000 code stream) are sent to the output module 9 for storage or transmission. At test step 49 is then performed and if no more code blocks are to be processed then the method 40 ends at a finish step 50, otherwise the method 40 returns to step 44 and another code block is selected.

As will be apparent to a person skilled in the art, the method may be selectively applied to one or more blocks of coded wavelet coefficients associated with bands derived from the image.

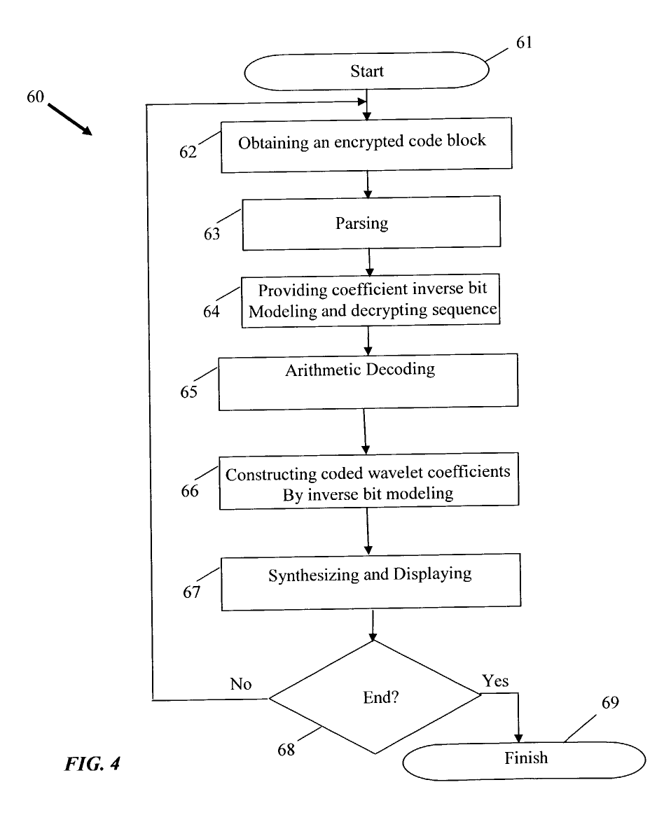

Referring to FIG. 4, there is illustrated a method 60 inverse bit modeling and decrypting a bit modeled and an encrypted version of a code block provided by the method 40. The bit modeled and an encrypted version of the code block comprises a context dependent modeled sequence of bits typically processed by the image coding method 40. At a start step 61 the input module 23 receives data and at an obtaining step 62 the input module 23 provides an encrypted version of a code block, coded by the method 40, for parsing 63 by the parsing module 26. The parsing module 26 parses the encrypted version and the processor 22 effects a providing a coefficient inverse bit modeling decrypting sequence 64. The decrypting sequence should be identical to encrypting sequence used to encrypt the code block and the sequence needs to be identified. In one form, the sequence may be identical for each image received in the form of encrypted code blocks, or alternatively the sequence may be identified by a header field in the received data of received at the start step 61. Typically, the decrypting sequence is identified by the key (seed), described above, and the decrypting sequence may therefore be created by pseudo-random number generation, provided by the processor 22, having an initial state provided by the encryption key (seed).

An arithmetic decoding step 65, performed by module 27, is then done in tandem with a constructing coded wavelet coefficients by inverse bit modeling step 66, performed by module 28. Step 66 constructs coded wavelet coefficients, by inverse bit modeling, from the context dependent modeled sequence of bits in an order identified by the decrypting sequence. This constructing provides a decrypted version of the code block 80. It should be noted that there can be a different inverse bit modeling order for different bit planes of the selected code block. The order, as will be apparent, is controlled by the decrypting sequence. Furthermore, the method 60 can be performed on other code blocks of the image with a different decrypting sequence thereby resulting in a different bit order for different code blocks.

After step 66, the wavelet synthesis module 29 provides a digital data representing an image that is displayed on module 30 at a synthesizing and displaying step 67. If desired, the digital data representing an image may be selectively stored in the memory module 31. At test 68 is then conducted to determine if there are any more code blocks to process, if there are more code blocks to process then the method 60 returns to step 62, otherwise the method 60 terminates an a finish step 69.

Advantageously, the present invention provides encryption and decryption for data compression coding techniques without dramatically affecting bit modeling and compression efficiency.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims.

We claim:

1. A method for bit modeling and encrypting a code block created from an image, the code block comprising a set of coded wavelet coefficients, the method comprising:
selecting the code block;
providing a coefficient bit modeling encrypting sequence;
and
conducting coefficient bit modeling on at least part of the selected code block in a bit modeling order identified by the encrypting sequence, the bit modeling providing a context dependent modeled wavelet sequence of bits for the selected code block, the wavelet sequence providing an encrypted version of the code block.

2. A method as claimed in claim 1, wherein there is a different bit modeling order for different bit planes of the selected code block, the order being controlled by the encrypting sequence.

3. A method as claimed in claim 1, wherein the method is performed on other code blocks of the image with a different said encrypting sequence thereby resulting in a different said order for different code blocks.

4. A method as claimed in claim 1, wherein the encrypting sequence is used during the selecting to thereby select the code block in an order identified by the encrypting sequence.

5. A method as claimed in claim 1, wherein the conducting coefficient bit modeling is followed by arithmetic encoding the modeled wavelet sequence of bits.

6. A method as claimed in claim 1, wherein the method is selectively applied to one or more blocks of coded wavelet coefficients associated with bands derived from the image during decomposing.

7. A method as claimed in claim 1, wherein the encrypting sequence is obtained by a pseudo-random number generation.

8. A method for inverse bit modeling and decrypting a bit modeled and an encrypted version of a code block for an image, the bit modeled and an encrypted version of the code block comprising a context dependent modeled sequence of bits, the method comprising:
obtaining the encrypted version of the code block;
providing an inverse bit modeling decrypting sequence; and
constructing coded wavelet coefficients from the context dependent modeled sequence of bits in an order identified by the decrypting sequence, the constructing providing a decrypted version of the code block.

9. A method as claimed in claim 8, wherein there is a different inverse bit modeling order for different bit planes of the selected code block, the order being controlled by the decrypting sequence.

10. A method as claimed in claim 8, wherein the method is performed on other code blocks of the image with a different said decrypting sequence thereby resulting in a different said order for different code blocks.

11. A method as claimed in claim 8, wherein arithmetic decoding of the modeled wavelet sequence of bits is performed prior to the conducting coefficient inverse bit modeling.

12. A method as claimed in claim 8, wherein the method is selectively applied to one or more blocks of coded wavelet coefficients associated with bands derived from the image.

13. A method as claimed in claim 8, wherein the decrypting sequence is obtained by a pseudo-random number generation.

14. A method as claimed in claim 8, wherein the decrypting sequence may be associated with a shared key used to create the bit modeled and an encrypted version of a code block.

15. A decoder system for inverse bit modeling and decrypting a bit modeled and an encrypted version of a code block for an image, the bit modeled and an encrypted version of the code block comprising a context dependent modeled sequence of bits, the decoder system comprising:
a processor providing an inverse bit modeling decrypting sequence;
an input module for obtaining the encrypted version of the code block; and
a coefficient inverse bit modeling module coupled to the input module and the processor, wherein in use, the inverse bit modeling module constructs coded wavelet coefficients from the context dependent modeled sequence of bits in an order identified by the decrypting sequence, to provide a decrypted version of the code block.

16. A decoder system, as claimed in claim 15, wherein the processor includes a pseudo-random number generator for providing the decrypting sequence.

17. A decoder system, as claimed in claim 15, wherein the decrypting sequence is associated with a shared key used to create the bit modeled and an encrypted version of a code block.

18. A decoder system, as claimed in claim 15, further including a display module coupled to the coefficient inverse bit modeling module.

19. A decoder system, as claimed in claim 15, further including a wavelet synthesis module coupling said display module to said inverse bit modeling module.

20. A decoder system, as claimed in claim 15, further including an arithmetic decoder module coupling said input module to said module coupling said inverse bit modeling module.
